(19) United States
(12) Patent Application Publication
(10) Pub. No.: US 2025/0247181 A1
(43) Pub. Date: Jul. 31, 2025

(54) METHOD OF UPLINK TRANSMISSION TIMING MANAGEMENT FOR MOBILITY, USER EQUIPMENT, AND BASE STATION

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/182,896

(22) Filed: Apr. 18, 2025

Related U.S. Application Data
(63) Continuation of application No. PCT/CN2023/137530, filed on Dec. 8, 2023.
(60) Provisional application No. 63/387,675, filed on Dec. 15, 2022.

(51) Int. Cl. H04L 5/00; H04W 36/00

(52) U.S. Cl. CPC H04L 5/0044; H04W 36/0072

(57) ABSTRACT

A method of uplink transmission timing management for mobility by a user equipment (UE) includes being configured to obtain an uplink transmission timing for a first cell based on a downlink transmission timing of a second cell, a downlink transmission timing of a first cell, and an uplink transmission timing towards the second cell.

### CROSS-REFERENCE TO RELATED APPLICATION

This application is a Continuation Application of International Application No. PCT/CN2023/137530 filed on Dec. 8, 2023, which claims priority to U.S. Provisional Application No. 63/387,675 filed on Dec. 15, 2022. The entire contents of all of the above-identified applications are incorporated herein by reference in their entirety.

### TECHNICAL FIELD

The present disclosure relates to the field of communication systems, and more particularly, to apparatuses and methods of uplink transmission timing management for mobility.

### RELATED ART

The drawback of current uplink transmission timing management is long latency in obtaining a timing advance of a target cell due to a required random access channel (RACH) procedure for obtaining timing advance. It would introduce large interrupt time during inter-cell mobility, and thus a system performance could be impaired.

Therefore, there is a need for apparatuses and methods of uplink transmission timing management for mobility.

### SUMMARY

An object of the present disclosure is to propose apparatuses and methods of uplink transmission timing management for mobility.

In a first aspect of the present disclosure, a method of uplink transmission timing management for mobility by a user equipment (UE) includes being configured to obtain an uplink transmission timing for a first cell based on a downlink transmission timing of a second cell, a downlink transmission timing of a first cell, and an uplink transmission timing towards the second cell.

In a second aspect of the present disclosure, a UE includes an obtainer configured to obtain an uplink transmission timing for a first cell based on a downlink transmission timing of a second cell, a downlink transmission timing of a first cell, and an uplink transmission timing towards the second cell.

In a third aspect of the present disclosure, a UE includes a memory, a transceiver, and a processor coupled to the memory and the transceiver. The UE is configured to perform the above method.

In a fourth aspect of the present disclosure, a method of uplink transmission timing management for mobility by a base station includes requesting a user equipment (UE) to obtain an uplink transmission timing for a first cell based on a downlink transmission timing of a second cell, a downlink transmission timing of a first cell, and an uplink transmission timing towards the second cell.

In a fifth aspect of the present disclosure, a base station includes a requester configured to request a user equipment (UE) to obtain an uplink transmission timing for a first cell based on a downlink transmission timing of a second cell, a downlink transmission timing of a first cell, and an uplink transmission timing towards the second cell.

In a sixth aspect of the present disclosure, a base station includes a memory, a transceiver, and a processor coupled to the memory and the transceiver. The base station is configured to provide the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a non-transitory computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures.

FIG. 1 is a block diagram of one or more user equipments (UEs) and a base station of communication in a communication network system according to an embodiment of the present disclosure.

FIG. 2 is a block diagram of a UE according to an embodiment of the present disclosure.

FIG. 3 is a block diagram of a UE according to an embodiment of the present disclosure.

FIG. 4 is a flowchart illustrating a method of uplink transmission timing management for mobility performed by a UE according to an embodiment of the present disclosure.

FIG. 5 is a block diagram of a base station according to an embodiment of the present disclosure.

FIG. 6 is a block diagram of a base station according to an embodiment of the present disclosure.

FIG. 7 is a flowchart illustrating a method of uplink transmission timing management for mobility performed by a base station according to an embodiment of the present disclosure.

FIG. 8 is a block diagram of an example of a computing device according to an embodiment of the present disclosure.

FIG. 9 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In the embodiments, a method of uplink transmission timing management for mobility is provided, which is performed by a user equipment (UE) and includes:
being configured to obtain an uplink transmission timing for a first cell based on a downlink transmission timing of a second cell, a downlink transmission timing of a first cell, and an uplink transmission timing towards the second cell.

In some embodiments, the second cell is a serving cell of the UE while the first cell is on a non-serving cell.

In some embodiments, the first cell is a candidate cell for mobility.

In some embodiments, the UE is configured with the serving cell and configured with one or more candidate cells for mobility.

In some embodiments, the UE is provided with information of downlink transmission timing of the serving cell and the one or more candidate cells for mobility.

In some embodiments, the method further includes being requested to measure/obtain a timing advance value of one candidate cell for mobility based on a timing advance value of the serving cell, the downlink transmission timing of the serving cell, the downlink transmission timing of the one or more candidate cells, a reception timing of downlink of the serving cell, and a reception timing of downlink of the one or more candidate cells for mobility.

In some embodiments, the method further includes being requested to report the timing advance value of the one or more candidate cells to the base station.

In some embodiments, the method further includes being requested to report information of reception timing of downlink of the one or more candidate cells to the base station.

In some embodiments, the UE is configured to report the timing advance value or the information of reception timing of downlink of the one or more candidate cells to the base station through a media access control (MAC) control element (CE) message or an uplink control information (UCI) message.

In some embodiments, the UE is configured to report one or more of the following information to the base station: one indicator used to indicate one candidate cell and bits used to indicate a value of uplink timing advance.

In some embodiments, the UE is configured to report one or more of the following information to the base station: one indicator used to indicate one candidate cell and bits used to indicate a value of downlink reception timing of the one or more candidate cells.

In the embodiments, a method of uplink transmission timing management for mobility is provided, which is performed by a base station and including:
requesting a user equipment (UE) to obtain an uplink transmission timing for a first cell based on a downlink transmission timing of a second cell, a downlink transmission timing of a first cell, and an uplink transmission timing towards the second cell.

In some embodiments, the second cell is a serving cell of the UE while the first cell is on a non-serving cell.

In some embodiments, the first cell is a candidate cell for mobility.

In some embodiments, the base station is used to configure the serving cell and one or more candidate cells for mobility to the UE.

In some embodiments, the base station provides information of downlink transmission timing of the serving cell and the one or more candidate cells for mobility to the UE.

In some embodiments, the method further includes requesting the UE to measure/obtain a timing advance value of one candidate cell for mobility based on a timing advance value of the serving cell, the downlink transmission timing of the serving cell, the downlink transmission timing of the one or more candidate cells, a reception timing of downlink of the serving cell, and a reception timing of downlink of the one or more candidate cells for mobility.

In some embodiments, the method further includes requesting the UE to report the timing advance value of the one or more candidate cells.

In some embodiments, the method further includes requesting the UE to report information of reception timing of downlink of the one or more candidate cells.

In some embodiments, the timing advance value or the information of reception timing of downlink of the one or more candidate cells is reported to the base station through a media access control (MAC) control element (CE) message or an uplink control information (UCI) message.

In some embodiments, the base station requests the UE to report one or more of the following information to the base station: one indicator used to indicate one candidate cell and bits used to indicate a value of uplink timing advance.

In some embodiments, the base station requests the UE to report one or more of the following information to the base station: one indicator used to indicate one candidate cell and bits used to indicate a value of downlink reception timing of the one or more candidate cells.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved PLMN, etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

New radio (NR) system supports an uplink timing control procedure for uplink transmission. The uplink timing control based on timing advance command is applied on a transmission of all uplink channels and reference signals including physical uplink shared channel (PUSCH), physical uplink control channel (PUCCH), and sounding reference signal (SRS) in NR. The NR system has multiple mechanisms to indicate timing advance information to a user equipment (UE). The first mechanism is physical random access channel (PRACH). During the RACH procedure, the UE transmits a PRACH preamble to a base station such as the gNB. The gNB can then measure uplink signal arrival timing and calculate a timing advance value accordingly. The gNB replies to random access response (RAR) to the UE and a RAR message contains the timing advance command. Another mechanism is timing advance media access control (MAC) control element (CE). The gNB uses the timing advance MAC CE to indicate one timing adjustment value to the UE, and the UE adjusts the timing advance value accordingly when such the MAC CE is received.

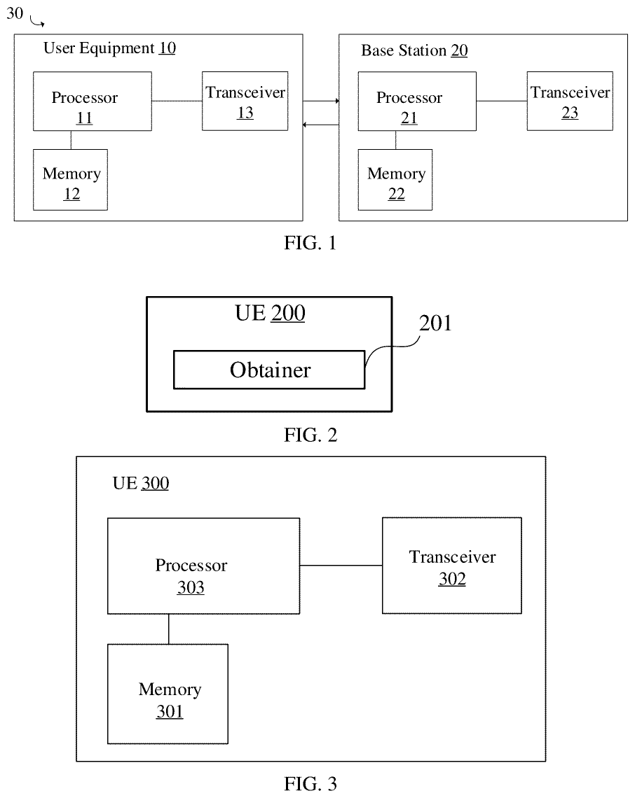

FIG. 1 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to obtain an uplink transmission timing for a first cell based on a downlink transmission timing of a second cell, a downlink transmission timing of a first cell, and an uplink transmission timing towards the second cells. This can solve issues in the prior art and other issues and/or reduce a latency of inter-cell mobility.

In some embodiments, the processor 21 is configured to request a user equipment (UE) to obtain an uplink transmission timing for a first cell based on a downlink transmission timing of a second cell, a downlink transmission timing of a first cell, and an uplink transmission timing towards the second cell. This can solve issues in the prior art and other issues and/or reduce a latency of inter-cell mobility.

FIG. 2 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes an obtainer 201 configured to obtain an uplink transmission timing for a first cell based on a downlink transmission timing of a second cell, a downlink transmission timing of a first cell, and an uplink transmission timing towards the second cell. This can solve issues in the prior art and other issues and/or reduce a latency of inter-cell mobility.

FIG. 3 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the processor 302 is configured to obtain an uplink transmission timing for a first cell based on a downlink transmission timing of a second cell, a downlink transmission timing of a first cell, and an uplink transmission timing towards the second cell. This can solve issues in the prior art and other issues and/or reduce a latency of inter-cell mobility.

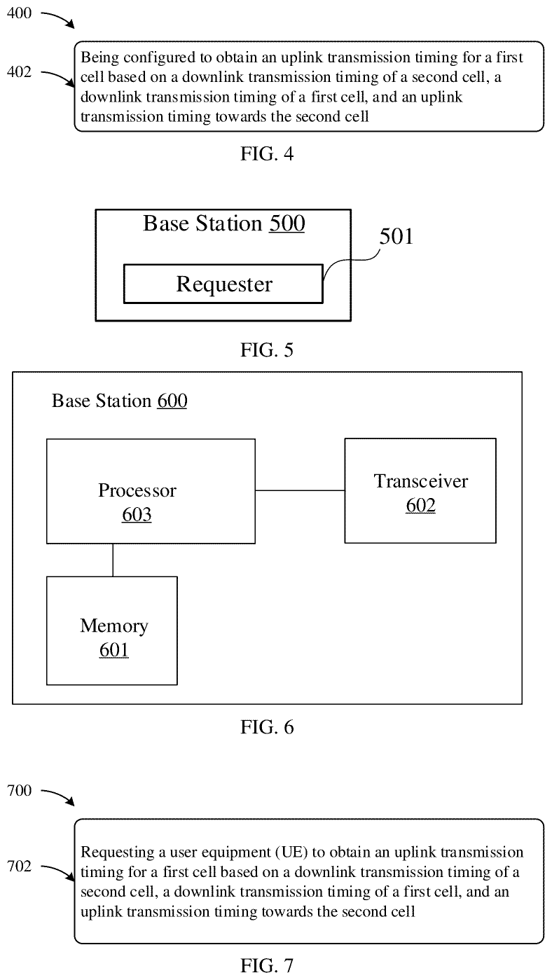

FIG. 4 is an example of a method 400 of uplink transmission timing management for mobility performed by a UE according to an embodiment of the present disclosure. The method 400 of uplink transmission timing management for mobility performed by a UE is configured to implement some embodiments of the disclosure. Some embodiments of the disclosure may be implemented into the method 400 of uplink transmission timing management for mobility performed by a UE using any suitably configured hardware and/or software. In some embodiments, the method 400 of uplink transmission timing management for mobility performed by a UE includes: an operation 402, being configured to obtain an uplink transmission timing for a first cell based on a downlink transmission timing of a second cell, a downlink transmission timing of a first cell, and an uplink transmission timing towards the second cell. This can solve issues in the prior art and other issues and/or reduce a latency of inter-cell mobility.

In some embodiments, the second cell is a serving cell of the UE while the first cell is on a non-serving cell. In some embodiments, the first cell is a candidate cell for mobility. In some embodiments, the UE is configured with the serving cell and configured with one or more candidate cells for mobility. In some embodiments, the UE is provided with information of downlink transmission timing of the serving cell and the one or more candidate cells for mobility.

In some embodiments, the method further includes being requested to measure/obtain a timing advance value of one candidate cell for mobility based on a timing advance value of the serving cell, the downlink transmission timing of the serving cell, the downlink transmission timing of the one or more candidate cells, a reception timing of downlink of the serving cell, and a reception timing of downlink of the one or more candidate cells for mobility. In some embodiments, the method further includes being requested to report the timing advance value of the one or more candidate cells to the base station. In some embodiments, the method further includes being requested to report information of reception timing of downlink of the one or more candidate cells to the base station.

In some embodiments, the UE is configured to report the timing advance value or the information of reception timing of downlink of the one or more candidate cells to the base station through a media access control (MAC) control element (CE) message or an uplink control information (UCI) message. In some embodiments, the UE is configured to report one or more of the following information to the base station: one indicator used to indicate one candidate cell and bits used to indicate a value of uplink timing advance. In some embodiments, the UE is configured to report one or more of the following information to the base station: one indicator used to indicate one candidate cell and bits used to indicate a value of downlink reception timing of the one or more candidate cells.

FIG. 5 illustrates an example of base station 500 according to an embodiment of the present application. The base station 500 is configured to implement some embodiments of the disclosure. Some embodiments of the disclosure may be implemented into the base station 500 using any suitably configured hardware and/or software. The base station 500 includes a requester 501 configured to request a user equipment (UE) to obtain an uplink transmission timing for a first cell based on a downlink transmission timing of a second cell, a downlink transmission timing of a first cell, and an uplink transmission timing towards the second cell. This can solve issues in the prior art and other issues and/or reduce a latency of inter-cell mobility.

FIG. 6 illustrates an example of a base station 600 according to an embodiment of the present disclosure. The base station 600 is configured to implement some embodiments of the disclosure. Some embodiments of the disclosure may be implemented into the base station 600 using any suitably configured hardware and/or software. The base station 600 may include a memory 601, a transceiver 602, and a processor 603 coupled to the memory 601 and the transceiver 602. The processor 603 may be configured to implement proposed functions, procedures and/or methods described in this description. Layers of radio interface protocol may be implemented in the processor 603. The memory 601 is operatively coupled with the processor 603 and stores a variety of information to operate the processor 603. The transceiver 602 is operatively coupled with the processor 603, and the transceiver 602 transmits and/or receives a radio signal. The processor 603 may include application-specific integrated circuit (ASIC), other chipset, logic circuit and/or data processing device. The memory 601 may include read-only memory (ROM), random access memory (RAM), flash memory, memory card, storage medium and/or other storage device. The transceiver 602 may include baseband circuitry to process radio frequency signals. When the embodiments are implemented in software, the techniques described herein can be implemented with modules (e.g., procedures, functions, and so on) that perform the functions described herein. The modules can be stored in the memory 601 and executed by the processor 603. The memory 601 can be implemented within the processor 603 or external to the processor 603 in which case those can be communicatively coupled to the processor 603 via various means as is known in the art.

In some embodiments, the processor 603 is configured to request a user equipment (UE) to obtain an uplink transmission timing for a first cell based on a downlink transmission timing of a second cell, a downlink transmission timing of a first cell, and an uplink transmission timing towards the second cell. This can solve issues in the prior art and other issues and/or reduce a latency of inter-cell mobility.

FIG. 7 is an example of a method 700 of uplink transmission timing management for mobility performed by a base station according to an embodiment of the present disclosure. The method 700 of uplink transmission timing management for mobility performed by the base station is configured to implement some embodiments of the disclosure. Some embodiments of the disclosure may be implemented into the method 700 of uplink transmission timing management for mobility performed by the base station using any suitably configured hardware and/or software. In some embodiments, the method 700 of uplink transmission timing management for mobility performed by the base station includes: an operation 702, requesting a user equipment (UE) to obtain an uplink transmission timing for a first cell based on a downlink transmission timing of a second cell, a downlink transmission timing of a first cell, and an uplink transmission timing towards the second cell. This can solve issues in the prior art and other issues and/or reduce a latency of inter-cell mobility.

In some embodiments, the second cell is a serving cell of the UE while the first cell is on a non-serving cell. In some embodiments, the first cell is a candidate cell for mobility. In some embodiments, the base station is used to configure the serving cell and one or more candidate cells for mobility to the UE. In some embodiments, the base station provides information of downlink transmission timing of the serving cell and the one or more candidate cells for mobility to the UE.

In some embodiments, the method further includes requesting the UE to measure/obtain a timing advance value of one candidate cell for mobility based on a timing advance value of the serving cell, the downlink transmission timing of the serving cell, the downlink transmission timing of the one or more candidate cells, a reception timing of downlink of the serving cell, and a reception timing of downlink of the one or more candidate cells for mobility.

In some embodiments, the method further includes requesting the UE to report the timing advance value of the one or more candidate cells. In some embodiments, the method further includes requesting the UE to report information of reception timing of downlink of the one or more candidate cells. In some embodiments, the timing advance value or the information of reception timing of downlink of the one or more candidate cells is reported to the base station through a media access control (MAC) control element (CE) message or an uplink control information (UCI) message. In some embodiments, the base station requests the UE to report one or more of the following information to the base station: one indicator used to indicate one candidate cell and bits used to indicate a value of uplink timing advance. In some embodiments, the base station requests the UE to report one or more of the following information to the base station: one indicator used to indicate one candidate cell and bits used to indicate a value of downlink reception timing of the one or more candidate cells.

### Exemplary Technical Solutions

In some embodiments, a UE can be configured to obtain uplink transmission timing for a first cell based on downlink transmission timing of a second cell, downlink transmission timing of the first cell, and uplink transmission timing towards the second cell. In some examples, the second cell can be a current serving cell of the UE while the first cell can be on non-serving cell. In some examples, the first cell can be of a candidate cell for mobility. The UE can be configured with a serving cell and configured with one or more candidate cells for mobility. The UE can be provided with information of downlink (DL) transmission timing of the serving cell and the one or more candidate cells for mobility.

In some embodiments, for the serving cell, the UE can be provided with a timing advance value for uplink transmission. Then the UE can be requested to measure/obtain the timing advance value of one candidate cell for mobility based on the timing advance value of the serving cell, the DL transmission timing of the serving cell, the DL transmission timing of the one or more candidate cells, the reception timing of DL of serving cell, and the reception timing of DL of the one or more candidate cells for mobility. Then the UE can be requested to report the obtained timing advance value of the one or more candidate cells to the system.

In some embodiments, the UE can be requested to report the information of reception timing of DL of the one or more candidate cells to the system. In some examples, the UE can report such information to the system through a MAC CE message. In some examples, the UE can report such information to the system through a UCI message. In some examples, the UE can report one or more of the following information to the system: one indicator that indicates one candidate cell and a few bits to indicate the value of uplink timing advance. In some examples, the UE can report one or more of the following information to the system: one indicator that indicates one candidate cell and a few bits to indicate the value of DL reception timing of candidate cell which can be one value with respect to the DL reception timing of the serving cell.

In a first exemplary method, a UE can be configured with a serving cell and a list of candidate cells for mobility. The UE can be requested to measure DL reception timing of one candidate cell in the list of candidate cells and then the UE can be requested to report the information of the DL reception timing of one candidate cell to a gNB.

In some examples, the UE can be requested to report one indicator of candidate cell in the configured list of candidate cells and a differential DL reception timing of the candidate cell. The differential DL reception timing of the candidate cell is calculated with respect to the DL reception timing of the serving cell.

In some examples, the UE can be requested to report the above information in a MAC CE message. In each MAC CE message, the UE can report one or more indicators of candidate cell in the configured list of candidate cells and for each reported indicator, the UE also report the differential DL reception timing of the corresponding candidate cell, where the differential DL reception timing of one candidate cell is calculated with respect to the DL reception timing of the serving cell.

In some examples, the UE can be requested to report the above information in a UCI message. In each UCI message, the UE can report one or more indicators of candidate cell in the configured list of candidate cells and for each reported indicator, the UE also report the differential DL reception timing of the corresponding candidate cell, where the differential DL reception timing of one candidate cell is calculated with respect to the DL reception timing of the serving cell.

In some examples, the gNB can use MAC CE, RRC, or DCI to request the UE to report the above information.

In some examples, the UE can be requested to report the above information when some condition is met. For example, when a reference signal received power (RSRP) measurement for mobility of one candidate cell is larger than some thresholds, the UE can report the above information of that candidate cell to the system.

In a second exemplary method, a UE can be configured with a serving cell and a list of candidate cells for mobility. The system can provide the DL transmission timing of the serving cell and the candidate cell in the configured list of candidate cell to the UE.

In some examples, for one candidate cell, the system can provide a DL transmission timing offset with respect to the serving cell to the UE. In some examples, for one candidate cell and the serving cell, the system can provide a DL transmission timing offset of each cell with respect to a particular reference time. In some examples, for one candidate cell and the serving cell, the system can provide a single frequency network (SFN) initialization time for each cell and the SFN initialization time is relative to a predefined reference time.

In some examples, with the provided configuration information, the UE can be requested to calculate the uplink timing advance of one candidate cell based on the DL transmission timing of the serving cell and of the candidate cell, and the uplink timing advance of the serving cell. The UE can be requested to report the calculated timing advance of one or more candidate cells.

In some examples, the UE can be requested to report one indicator of candidate cell in the configured list of candidate cells and information of uplink advance timing of the candidate cell. For example, the reported information of the uplink advance timing of the candidate cell can be the value of the timing advance of the candidate cell. For example, the reported information of the uplink timing advance of the candidate cell be a relative value with respect to the timing advance of the serving cell.

In some examples, the UE can be requested to report the above information in a MAC CE message. In each MAC CE message, the UE can report one or more indicators of candidate cell in the configured list of candidate cells and for each reported indicator, the UE also reports the uplink timing advance of the corresponding candidate cell. For example, the UE can report one relative value with respect to the uplink timing advance of the serving cell for each reported candidate cell.

In some examples, the UE can be requested to report the above information in a UCI message. In each UCI message, the UE can report one or more indicators of candidate cell in the configured list of candidate cells and for each reported indicator, the UE also reports the uplink timing advance of the corresponding candidate cell. For example, the UE can report one relative value with respect to the uplink timing advance of the serving cell for each reported candidate cell.

In some examples, the gNB can use MAC CE, RRC or DCI to request the UE to report the above information. In some examples, the UE can be requested to report the above information when some conditions are met. For example, when a RSRP measurement for mobility of one candidate cell is larger than some thresholds, the UE can report the above information of that candidate cell to the system.

In some examples, the UE can be requested to obtain the uplink timing advance for a first candidate cell in the configured list of candidate cells for mobility according to the above methods. The UE can be requested to apply the obtained uplink timing advance on the uplink transmission after the UE switches to the first candidate cell during inter-cell mobility, where the first candidate cell is the target cell of the inter-cell mobility. The gNB can send a cell switch command to the UE to indicate the UE to switch from serving cell to one candidate cell. For example, the cell switch command can be one MAC CE command.

In the cell switch command (for example MAC CE), the gNB can provide the following information:

One value of timing advance for uplink transmission in the target cell.

One indicator to indicate whether the UE applies the uplink timing advance that is obtained by the UE or the uplink timing advance provided by the system on uplink transmission in the target cell.

One indicator of a candidate cell that indicates the target cell.

One indicator of TCI state for target cell. In some examples, one indicator of one joint TCI state. In some examples, one indicator of DL TCI state and one indicator of UL TCI state.

In some examples, with the proposed method, the NR system is able to obtain the uplink timing advance of candidate cell with low latency and thus the system performance of inter-cell mobility is improved.

Commercial interests for some embodiments are as follows. 1. Solve issues in the prior art and other issues. 2. Reduce a latency of inter-cell mobility. 3. Provide a good communication performance. 4. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of uplink transmission timing management for mobility are considered for standardizing.

FIG. 8 is an example of a computing device 1100 according to an embodiment of the present disclosure. Any suitable computing device can be used for performing the operations described herein. For example, FIG. 8 illustrates an example of the computing device 1100 that can implement some embodiments of FIG. 1 to FIG. 7 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

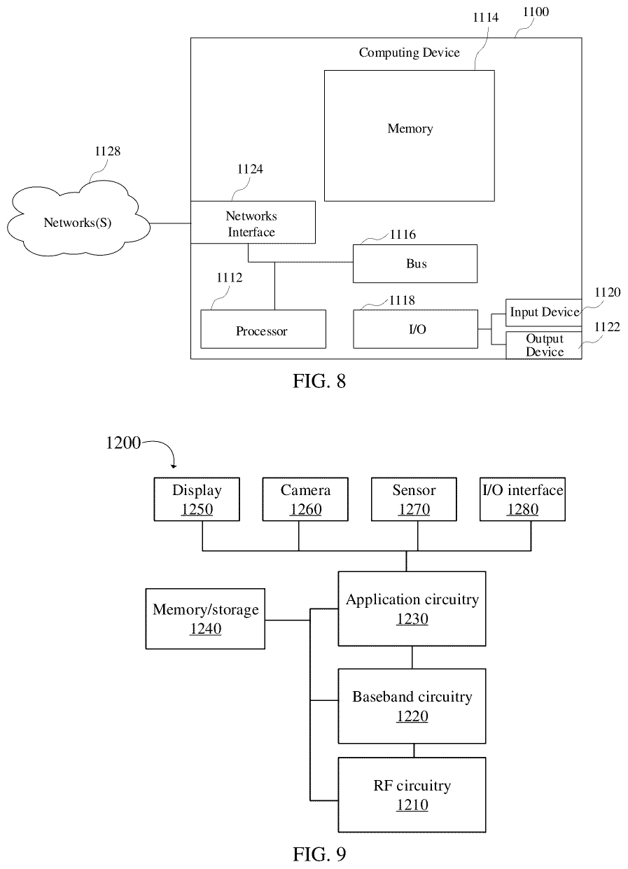

FIG. 9 is a block diagram of an example of a communication system 1200 according to an embodiment of the present disclosure. Embodiments described herein may be implemented into the communication system 1200 using any suitably configured hardware and/or software. FIG. 9 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 7. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 7 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments arc exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a non-transitory readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the exemplary embodiments, it is understood that the present disclosure is not limited to the disclosed embodiments but is intended to cover various arrangements made without departing from the scope of the broadest interpretation of the appended claims.

What is claimed is:

1. A method of uplink transmission timing management for mobility, by a user equipment (UE), comprising:
being configured to obtain an uplink transmission timing for a first cell based on a downlink transmission timing of a second cell, a downlink transmission timing of a first cell, and an uplink transmission timing towards the second cell.

2. The method of claim 1, wherein the second cell is a serving cell of the UE while the first cell is on a non-serving cell;
wherein the first cell is a candidate cell for mobility.

3. The method of claim 2, wherein the UE is configured with the serving cell and configured with one or more candidate cells for mobility;
wherein the UE is provided with information of downlink transmission timing of the serving cell and the one or more candidate cells for mobility.

4. The method of claim 3, further comprising being requested to measure/obtain a timing advance value of one candidate cell for mobility based on a timing advance value of the serving cell, the downlink transmission timing of the serving cell, the downlink transmission timing of the one or more candidate cells, a reception timing of downlink of the serving cell, and a reception timing of downlink of the one or more candidate cells for mobility.

5. The method of claim 4, further comprising being requested to report the timing advance value of the one or more candidate cells to a base station;
and/or
further comprising being requested to report information of reception timing of downlink of the one or more candidate cells to the base station.

6. The method of claim 5, wherein the UE is configured to report the timing advance value or the information of reception timing of downlink of the one or more candidate cells to the base station through a media access control (MAC) control element (CE) message or an uplink control information (UCI) message.

7. The method of claim 5, wherein the UE is configured to report one or more of the following information to the base station: one indicator used to indicate one candidate cell and bits used to indicate a value of uplink timing advance;
or
the UE is configured to report one or more of the following information to the base station: one indicator used to indicate one candidate cell and bits used to indicate a value of downlink reception timing of the one or more candidate cells.

8. A user equipment (UE), comprising:
a memory;
a transceiver; and
a processor coupled to the memory and the transceiver;
wherein the UE is configured to perform:
obtaining an uplink transmission timing for a first cell based on a downlink transmission timing of a second cell, a downlink transmission timing of a first cell, and an uplink transmission timing towards the second cell.

9. The UE of claim 8, wherein the second cell is a serving cell of the UE while the first cell is on a non-serving cell;
wherein the first cell is a candidate cell for mobility.

10. The UE of claim 9, wherein the UE is configured with the serving cell and configured with one or more candidate cells for mobility;
wherein the UE is provided with information of downlink transmission timing of the serving cell and the one or more candidate cells for mobility.

11. The UE of claim 10, wherein the UE is further configured to perform:
measuring/obtaining a timing advance value of one candidate cell for mobility based on a timing advance value of the serving cell, the downlink transmission timing of the serving cell, the downlink transmission timing of the one or more candidate cells, a reception timing of downlink of the serving cell, and a reception timing of downlink of the one or more candidate cells for mobility.

12. The UE of claim 11, wherein the UE is further configured to perform: being requested to report the timing advance value of the one or more candidate cells to a base station;
and/or
the UE is further configured to perform: being requested to report information of reception timing of downlink of the one or more candidate cells to the base station.

13. The UE of claim 12, wherein the UE is configured to report the timing advance value or the information of reception timing of downlink of the one or more candidate cells to the base station through a media access control (MAC) control element (CE) message or an uplink control information (UCI) message.

14. The UE of claim 12, wherein the UE is configured to report one or more of the following information to the base station: one indicator used to indicate one candidate cell and bits used to indicate a value of uplink timing advance;
or
the UE is configured to report one or more of the following information to the base station: one indicator used to indicate one candidate cell and bits used to indicate a value of downlink reception timing of the one or more candidate cells.

15. A base station, comprising:
a memory;
a transceiver; and
a processor coupled to the memory and the transceiver;
wherein the base station is configured to perform:
requesting a user equipment (UE) to obtain an uplink transmission timing for a first cell based on a downlink transmission timing of a second cell, a downlink transmission timing of a first cell, and an uplink transmission timing towards the second cell.

16. The base station of claim 15, wherein the second cell is a serving cell of the UE while the first cell is on a non-serving cell;
wherein the first cell is a candidate cell for mobility.

17. The base station of claim 16, wherein the base station is used to configure the serving cell and one or more candidate cells for mobility to the UE;
wherein the base station provides information of downlink transmission timing of the serving cell and the one or more candidate cells for mobility to the UE.

18. The base station of claim 17, the base station is further configured to perform: requesting the UE to measure/obtain a timing advance value of one candidate cell for mobility based on a timing advance value of the serving cell, the downlink transmission timing of the serving cell, the downlink transmission timing of the one or more candidate cells, a reception timing of downlink of the serving cell, and a reception timing of downlink of the one or more candidate cells for mobility.

19. The base station of claim 18, the base station is further configured to perform: requesting the UE to report the timing advance value of the one or more candidate cells;
and/or
the base station is further configured to perform: requesting the UE to report information of reception timing of downlink of the one or more candidate cells.

20. The base station of claim 19, wherein the base station requests the UE to report one or more of the following information to the base station: one indicator used to indicate one candidate cell and bits used to indicate a value of uplink timing advance;
or
the base station requests the UE to report one or more of the following information to the base station: one indicator used to indicate one candidate cell and bits used to indicate a value of downlink reception timing of the one or more candidate cells.
